(19) United States
(12) Patent Application Publication
(10) Pub. No.: US 2016/0324307 A1
(43) Pub. Date: Nov. 10, 2016

(54) Paintbrush Cleaning Assembly

(71) Applicant: Charles Steve Stanley, Franklin, NC (US)

(72) Inventor: Charles Steve Stanley, Franklin, NC (US)

(21) Appl. No.: 14/707,067

(22) Filed: May 8, 2015

(51) Int. Cl. A46B 17/06; B08B 3/10

(52) U.S. Cl. CPC A46B 17/06; B08B 3/10

(57) ABSTRACT

A paint brush cleaning assembly includes a tray that is structured to have an alternating sequence of peaks and valleys. The peaks and valleys may have a paint brush brushed against the peaks and valleys. A valve is coupled to the tray and the valve selectively restricts and allows a flow of a fluid through the valve. The valve may be fluidly coupled to a fluid source. A hose is fluidly coupled to the valve wherein the hose directs the flow of fluid onto the tray. The fluid rinses the paint brush while the paint brush is brushed against the peaks and valleys thereby facilitating the paint brush to be cleaned.

### BACKGROUND OF THE DISCLOSURE

### Field of the Disclosure

The disclosure relates to cleaning devices and more particularly pertains to a new cleaning device for cleaning a paint brush.

### SUMMARY OF THE DISCLOSURE

An embodiment of the disclosure meets the needs presented above by generally comprising a tray that is structured to have an alternating sequence of peaks and valleys. The peaks and valleys may have a paint brush brushed against the peaks and valleys. A valve is coupled to the tray and the valve selectively restricts and allows a flow of a fluid through the valve. The valve may be fluidly coupled to a fluid source. A hose is fluidly coupled to the valve wherein the hose directs the flow of fluid onto the tray. The fluid rinses the paint brush while the paint brush is brushed against the peaks and valleys thereby facilitating the paint brush to be cleaned.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective in-use view of a paint brush cleaning assembly according to an embodiment of the disclosure.

FIG. 2 is a top view of an embodiment of the disclosure.

FIG. 3 is a right side phantom view of an embodiment of the disclosure.

FIG. 4 is a right side cut away view of an embodiment of the disclosure.

FIG. 5 is a right side in-use view of an embodiment of the disclosure.

### DESCRIPTION OF THE PREFERRED EMBODIMENT

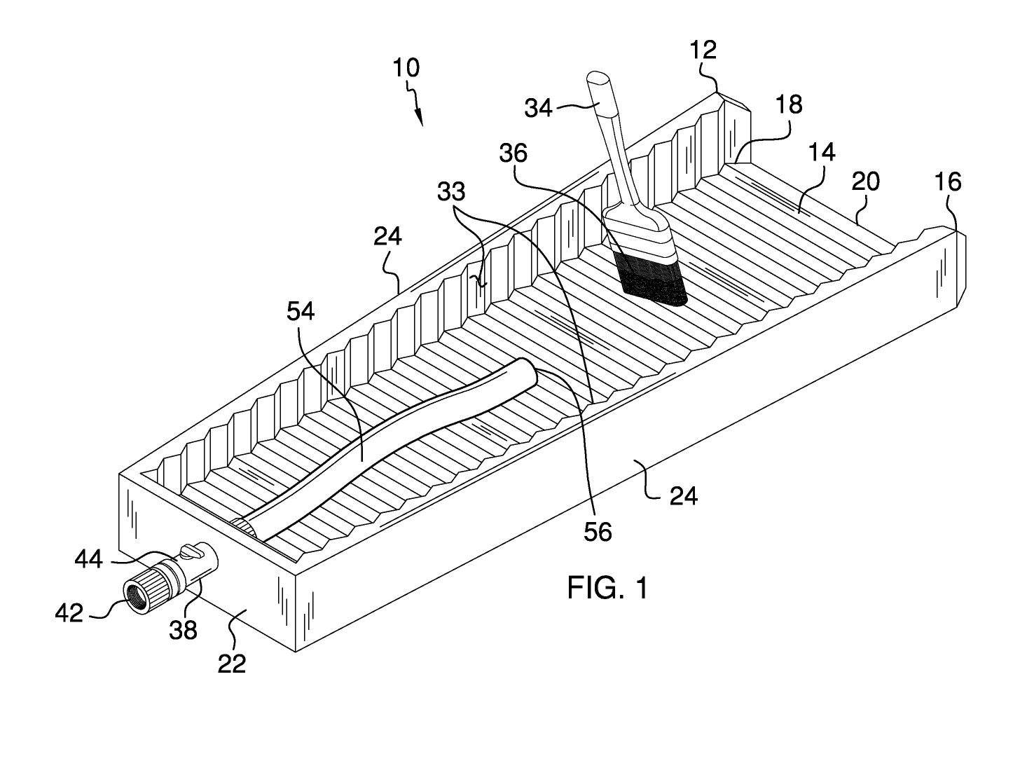

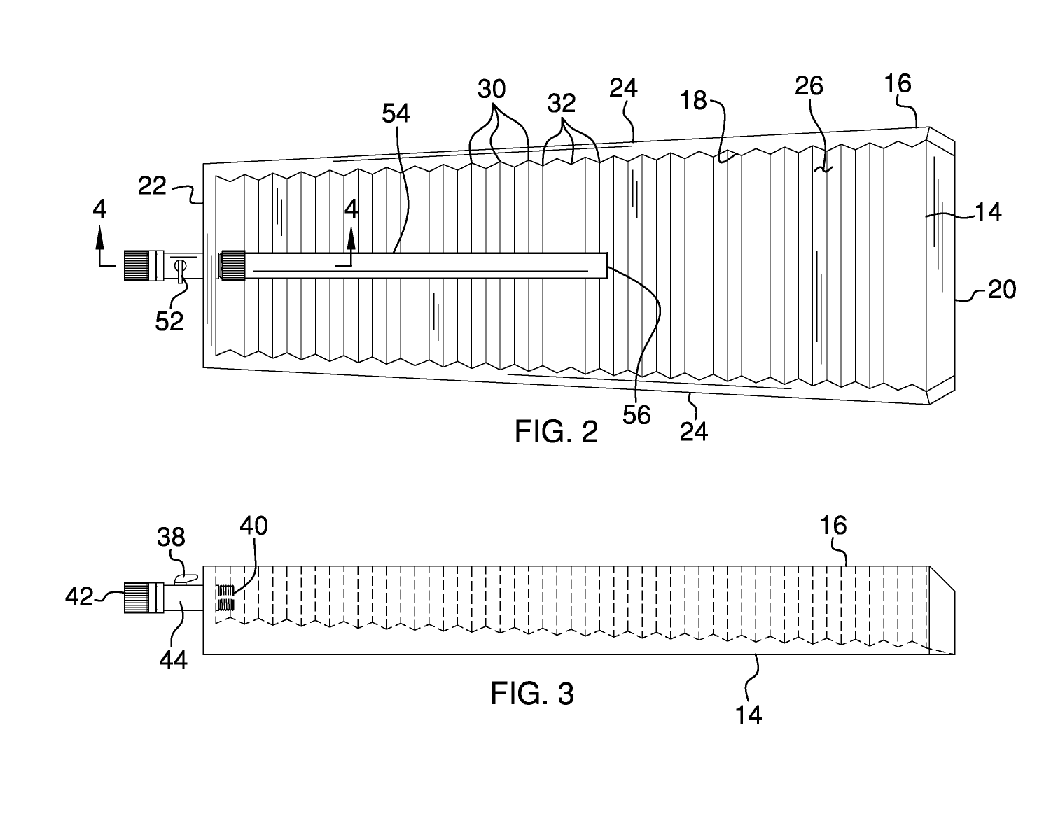

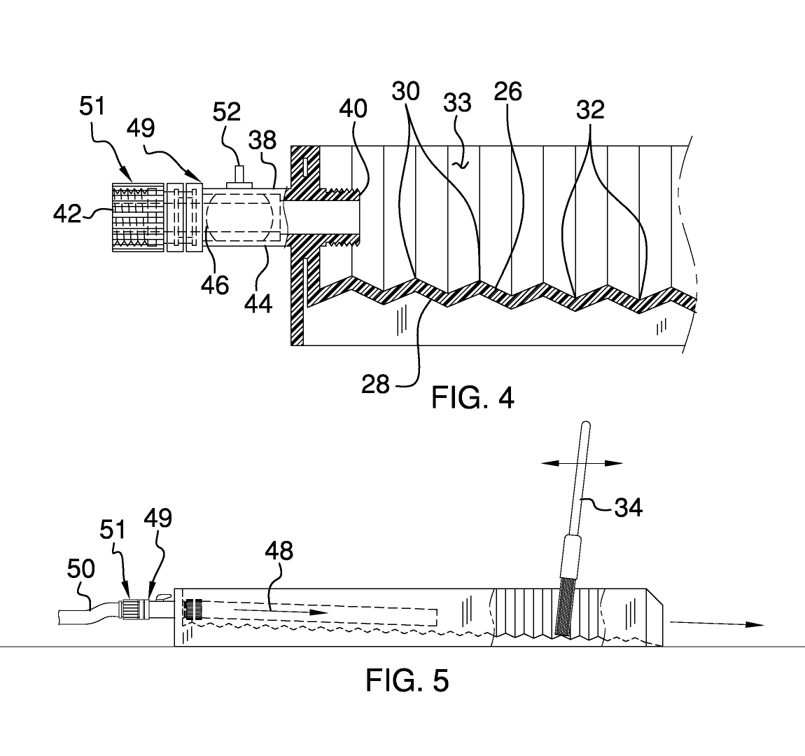

With reference now to the drawings, and in particular to FIGS. 1 through 5 thereof, a new cleaning device embodying the principles and concepts of an embodiment of the disclosure and generally designated by the reference numeral 10 will be described.

As best illustrated in FIGS. 1 through 5, the paint brush cleaning assembly 10 generally comprises a tray 12 that has a bottom wall 14 and a peripheral wall 16 coupled to and extending upwardly from a perimeter edge 18 of the bottom wall 14. The peripheral wall 16 has a front side 20, a back side 22 and a pair of lateral sides 24. The front side 20 is open and the peripheral wall 16 tapers outwardly between the back side 22 and the front side 20 such that the front side 20 has a width that is greater than a width of the back side 22.

The bottom wall 14 has a top surface 26 and a bottom surface 28 and the top surface 26 slopes downwardly between the back side 22 and the front side 20. The top surface 26 comprises an alternating sequence of peaks 30 and valleys 32 and the peaks 30 and valleys 32 extend between the lateral sides 24. The peaks 30 and valleys 32 are spaced apart from each other and distributed between the front side 20 and the back side 22. Each of the lateral sides 24 has an inwardly facing surface 33 and the peaks 30 and valleys 32 extend upwardly along the inwardly facing surface 33 of each of the lateral sides 24. The peaks 30 and valleys 32 may have a paint brush 34 being brushed against the peaks 30 and valleys 32. The paint brush 34 may be a paint brush or a paint roller of any conventional design and the paint brush 34 may be soaked with a liquid paint 36.

A valve 38 is provided that has a first end 40, a second end 42 and an outer wall 44 extending between the first end 40 and the second end 42. Each of the first end 40 and the second end 42 are open and the valve 38 is substantially hollow. The valve 38 has a shutoff 46 positioned within the valve 38. The shutoff 46 is positioned between an open position and a closed position wherein the shutoff 46 selectively restricts and allows a flow of a fluid 48 through the valve 38. The valve 38 is coupled to the tray 12 and the valve 38 extends through the back side 22 having the first end 40 being positioned within the tray 12. The second end 42 may be fluidly coupled to a fluid source 50. The fluid source 50 may be a garden hose or the like and the fluid 48 may comprise water.

The outer wall 44 of the valve has a first section 49 that is rotatably coupled to a second section 51. The second section 51 is positioned adjacent to the second end 42 and the second section 51 may be rotated to fluidly couple the second end 42 to the fluid source 50. The second section 51 prevents the fluid source 50 from twisting or becoming tangled when the fluid source 50 is fluidly coupled to the second end 42.

A handle 52 is movably attached to the valve 38. The handle 52 is in mechanical communication with the shutoff 46 wherein the handle 52 positions the shutoff 46 between the open position and the closed position. The valve 38 may be a fluid valve of any conventional design. A hose 54 is fluidly coupled to the first end 40 of the valve 38. The hose 54 has a distal end 56 with respect to the first end 40 wherein the distal end 56 directs the flow of the fluid 48 onto the top surface 26 of the tray 12. Thus, the fluid 48 runs downwardly along the top surface 26 and outwardly from the front side 20. The fluid 48 rinses the paint brush 34 while the paint brush 34 is brushed against the peaks 30 and valleys 32 thereby facilitating the paint brush 34 to be cleaned.

In use, the valve 38 is fluidly coupled to the fluid source 50 and the handle 52 is manipulated to position the shutoff 46 in the open position. The paint brush 34 is brushed against the peaks 30 and valleys 32 when the paint brush 34 needs to be cleaned. The fluid 48 rinses the liquid paint 36 from the paint brush 34 and the peaks 30 and valleys 32 serve to agitate the liquid paint 36 outwardly from the paint brush 34. The mixture of the fluid 48 and the liquid paint 36 flows outwardly from the front side 20 of the tray 12. The paint brush 34 is brushed against the peaks 30 and valleys 32 until the paint brush 34 is cleaned of the liquid paint 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A paint brush cleaning assembly comprising:
a tray being structured to have an alternating sequence of peaks and valleys wherein said peaks and valleys are configured to have a paint brush being brushed against said peaks and valleys;
a valve being coupled to said tray wherein said shutoff is configured to selectively restrict and allow a flow of a fluid through said valve, said valve being configured to be fluidly coupled to a fluid source; and
a hose being fluidly coupled to said valve wherein said hose is configured to direct the flow of fluid onto said tray, the fluid rinsing the paint brush while the paint brush is brushed against said peaks and valleys thereby facilitating the paint brush to be cleaned.

2. The assembly according to claim 1, wherein said tray has a bottom wall and a peripheral wall coupled to and extending upwardly from a perimeter edge of said bottom wall, said peripheral wall having a front side, a back side and a pair of lateral sides, said front side being open, said peripheral wall tapering outwardly between said back side and said front side such that said front side has a width being greater than a width of said back side, said bottom wall having a top surface and a bottom surface, said top surface sloping downwardly between said back side and said front side.

3. The assembly according to claim 2, wherein said top surface comprises said alternating sequence of peaks and valleys, said peaks and valleys extending between said lateral sides, said peaks and valleys being spaced apart from each other and distributed between said front side and said back side.

4. The assembly according to claim 1, wherein:
said tray has a back side; and
said valve has a first end, a second end and an outer wall extending between said first end and said second end, each of said first end and said second end being open, said valve being substantially hollow, said valve having a shutoff positioned within said valve, said shutoff being positioned between an open position and a closed position, said valve extending through said back side having said first end being positioned within said tray.

5. The assembly according to claim 4, further comprising a handle being movably attached to said valve, said handle being in mechanical communication with said shutoff wherein said handle positions said shutoff between said open position and said closed position.

6. The assembly according to claim 1, wherein:
said valve has a first end;
said tray has a top surface and a front end; and
said hose has a distal end with respect to said first end such that the fluid runs downwardly along said top surface and outwardly from said front side.

7. A paint brush cleaning assembly comprising:
a tray having a bottom wall and a peripheral wall coupled to and extending upwardly from a perimeter edge of said bottom wall, said peripheral wall having a front side, a back side and a pair of lateral sides, said front side being open, said peripheral wall tapering outwardly between said back side and said front side such that said front side has a width being greater than a width of said back side, said bottom wall having a top surface and a bottom surface, said top surface sloping downwardly between said back side and said front side, said top surface comprising an alternating sequence of peaks and valleys, said peaks and valleys extending between said lateral sides, said peaks and valleys being spaced apart from each other and distributed between said front side and said back side wherein said peaks and valleys are configured to have a paint brush being brushed against said peaks and valleys;
a valve having a first end, a second end and an outer wall extending between said first end and said second end, each of said first end and said second end being open, said valve being substantially hollow, said valve having a shutoff positioned within said valve, said shutoff being positioned between an open position and a closed position wherein said shutoff is configured to selectively restrict and allow a flow of a fluid through said valve, said valve being coupled to said tray, said valve extending through said back side having said first end being positioned within said tray, said second end being configured to be fluidly coupled to a fluid source;
a handle being movably attached to said valve, said handle being in mechanical communication with said shutoff wherein said handle positions said shutoff between said open position and said closed position; and
a hose being fluidly coupled to said first end, said hose having a distal end with respect to said first end wherein said distal end is configured to direct the flow of fluid onto said top surface of said tray such that the fluid runs downwardly along said top surface and outwardly from said front side, the fluid rinsing the paint brush while the paint brush is brushed against said peaks and valleys thereby facilitating the paint brush to be cleaned.
